(19) United States
(12) Patent Application Publication
(10) Pub. No.: US 2008/0008340 A1
(43) Pub. Date: Jan. 10, 2008

(54) HEARING DEVICE WITH PERIPHERAL IDENTIFICATION UNITS

(75) Inventors: Herbert Bachler, Meilen (CH); Christian Berg, Uerikon (CH)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 11/859,182

(22) Filed: Sep. 21, 2007

Related U.S. Application Data
(63) Continuation of application No. 09/610,284, filed on Jul. 6, 2000, now Pat. No. 7,286,678.
Application No. 09/610,284 is a continuation of application No. PCT/CH98/00502, filed on Nov. 24, 1998.

(51) Int. Cl. H04R 25/00

(52) U.S. Cl. 381/314

(57) ABSTRACT

Hearing aid fitted with a central processing unit (1) having peripherals (3E, 3A) connected to its input and output respectively. Each peripheral includes an identification unit (5) having an the output connected to a first input of a comparator (9). A second input of the comparator is connected to a read-only identification memory (11) containing identification features of the peripherals. An output of the comparator drives a configuration memory (15). As a result, the hearing aid self-identifies its current configuration based on the identification of the peripherals.

### CROSS REFERENCED TO RELATED APPLICATION

The present application is a Continuation of U.S. application Ser. No. 09/610,284, filed Jul. 6, 2000, which is a Continuation of International Application No. PCT/CH98/00502, which has an international filing date of Nov. 24, 1998.

### BACKGROUND OF THE INVENTION

The present invention relates to a hearing aid defined in the preamble of claim 1 and to a method, defined in the preamble of claim 9, for manufacturing a hearing aid.

Hearing aids are exceedingly complex systems. To meet a user's particular needs, a large number of different variations of hardware configurations must be made available. As a result manufacture, marketing and hearing-aid fitting incur very high costs, for instance manufacture requires setting up numerous different hearing-aid configurations which must be appropriately labeled and monitored and marketing requires commensurate stocking, while hearing-aid fitting must match the user's particular needs and different procedures are required depending on the particular hearing-aid configurations.

### BRIEF SUMMARY OF THE INVENTION

Starting with a hearing aid of the above cited kind, it is the objective of the present invention to solve this problem. For that purpose, at least some of the peripherals shall comprise an identifying unit of which the output is connected to the input of a comparator. An identification memory is connected to the input of said comparator. At its output, the comparator drives a configuration memory.

Because at least some, preferably all peripherals identify themselves and because the comparator—on the basis of the incoming identifications from the peripherals and following comparison with several possibilities of connecting such peripherals—shall store such a particular hardware configuration, the following significant advantages are attained:

Once assembled, the hearing aid is self-identifying in that by means of the comparator it has ascertained its configuration in terms of peripherals.

Because this self-identification requiring no writing—for instance on the packaging circumvents sources of errors in production quality controls, in marketing and fitting the hearing aids, it being impossible to test, deliver or fit a hearing aid that would be of another peripheral configuration.

In a preferred embodiment of the present invention, the comparator output is connected to an operationally selective input at the signal processing unit. As a result only such processing is feasible at the signal processing unit—whether for operational purposes per se or already for implementation—which also are admissible for the actual system constellation at hand. Operational programs which for instance must be implemented in wireless manner can be tested in this way for the admissibility of the predominant system constellation.

A further preferred embodiment of the hearing aid of the invention sets up the connection between peripherals and the central signal processor by means of a bus and interfaces. It is clear that in a conventional hearing aid the central digital processing unit must be connected hardware to hardware to the particular peripherals. The more options there are regarding the peripherals, the more connections must be provided for the central processing unit. This number increasingly affects the required chip area of the cited signal processing unit, and this feature is exceedingly disadvantageous in the desired miniaturization of hearing aids. Because the cited connections take place through a bus and interfaces, it is feasible to minimize the number of those hardware connections which are used in the hardware configuration of the state of the art, and the signals applied to said connections can be recognized and interpreted in configuration-specific manner by the signal processing unit. Applicable peripherals include microphones etc, sensors in general, loudspeakers etc., actuators in general, transceivers, i.e. wireless transmitters and/or receivers, manually operated selection switches, loudspeaker volume controls (potentiometers), read-only memories for instance processing parameters for the signal processing unit, read/write memories for instance for processing protocols, etc.

These peripherals can be generically divided into a first category of audio signal components such as sensors, actuators, amplifiers, filters and into a second category of control components such as transceivers, selection switches, memories etc.

Preferably a first bus with first interfaces is used for the first category and a second bus with second interfaces is used for the second category. In a further preferred mode, the first interfaces are designed as at least three-wire interfaces, the second interfaces are designed as at least two-wire interfaces. Appropriate interfaces on one hand are I²S as three-wire interfaces and I²C as two-wire interfaces, both marketed by Philips.

In principle however the hookup of signal-processing-unit/bus/peripherals also can be implemented by means of other interfaces, for instance AES-3 interfaces from the Audio Engineering Society and/or SPI Motorola interfaces.

The actual configuration also determines which signals are being transmitted to the central processing unit and hence which parameters. If peripheral identification is automated at the hearing aid of the invention, it will also be possible to automatically activate those signal processing configurations from a plurality of such which do correspond to the prevailing configuration with peripherals, or to drive them externally for instance using a transceiver, that is in wireless manner. As a result the problem of hearing-aid signal processing which does not at all correspond to the present configuration including peripherals shall be eliminated.

In a further preferred embodiment, the hearing aid of the invention comprises an output connected to the configuration memory at the hearing aid. In this way it is feasible—when hooking up the hearing aid to a computer-assisted fitting apparatus—that the hearing aid in its present configuration shall call up said apparatus and identify itself, whereby errors caused by erroneous hearing-aid assumptions shall be excluded. This communication as well may be wireless in that the cited output is provided by a transceiver.

A method of the invention for manufacturing a hearing aid is defined by the features of claim 10. Further preferred implementations of the manufacturing method of the invention are specified in the further claims.

### BRIEF DESCRIPTION OF THE DRAWINGS

The invention is elucidated below in relation to the attached drawings.

FIG. 1 is a signal-flow/functional-block diagram showing the basic principle of the hearing aid of the invention,

FIG. 2 shows a preferred design of the hearing aid of the invention, and

FIG. 3 shows a preferred embodiment of the invention's hearing aid designed as in FIG. 2.

### DETAILED DESCRIPTION OF THE INVENTION

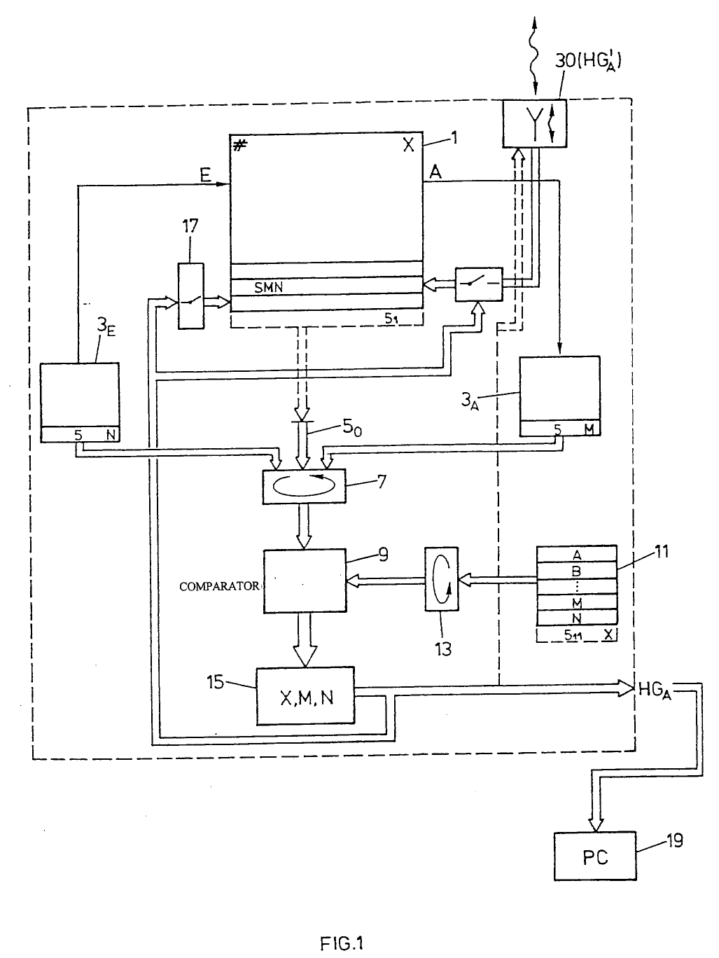

As shown in FIG. 1, a hearing aid of the invention comprises a central digital signal processing unit 1 having signal inputs E and signal outputs A. Peripherals 3_{E} and 3_{A} are connected to the signal inputs and outputs E and A. The peripherals 3_{E} for instance may be sensors such as microphones, more generally acoustic/electric transducers, or control units such as a remote control with transceiver, program switches, a loudspeaker volume adjustment etc. As regards the peripheral 3_{A}, in particular actuators may be involved such as one or several electric/mechanical or electric/electric output transducers.

As shown in FIG. 1, at least one peripheral 3_{E} is provided at the input side and at least one peripheral 3_{A} at the output side of the signal processing unit 1. Digital and/or analogue inputs with subsequent analog/digital converters (omitted) are present at the central processing unit in relation to the signals transmitted by the peripherals 3_{E}. In similar manner digital outputs and/or analogue outputs preceded by digital/analog converters are present at the output side of said unit 1 in relation to the signals processed by the peripheral 3_{A}.

Each of the minimum of two peripherals 3 comprises an identification memory 5. The information stored in the identification memories 5 is highly specific to the kind of peripheral involved, for instance the kind of microphone, remote control etc.

Following hardware configuration of the hearing aid, an identification cycle begins. Therein, and as schematically indicated by the cycle unit 7, illustratively all identification memories 5 are searched sequentially and an appropriate determination is made that no peripherals are hooked up to the dummy connection 5ᵣ. The unit 7 feeds the memory contents of the identification memories 5 to a comparator 9. All peripherals appropriate for the signal processing unit 1 together with their pertinent identifications are entered in a read-only memory 11.

To make sure that the signal processing unit 1 and the read-only memory 11 also correspond to each other in the sense that the memory 11 in fact does contain identification features of peripherals which also match the particular signal processing unit 1, the first step in identification may be in comparing an identification entry stored in an identification memory 5₁ of the signal processing unit 1 through the cycle unit 7 and the comparator 9 with the contents deposited at the read-only memory 11 in its own identification memory 5₁₁, and identifying this memory or contents.

As schematically indicated by the circulating unit 13, a sequential determination takes place at the comparator 9, by means of the entries in the identification memories 5 which of the kinds of peripherals 3 previously stored in the read-only memory 11 are at all present in the hearing-aid under consideration, and which are not. If there is a model X signal processing unit 1, and peripherals of types M and N are called for, then the output of the comparator stores the hearing aid configuration X, M, N in a hearing-aid configuration memory 15, and, as shown in relation to the read-only memory 11, further peripherals of types A, B etc. might be combined with the called-for X model signal processing unit 1.

The output of the configuration memory 15 drives the signal processing unit 1. In the light of the present hardware configuration as shown by the switch 17 in FIG. 1, a specific processing mode is activated at the signal processing unit 1, corresponding to S_{MN}, or is enabled. If the software of the processing mode has not yet been loaded into the signal processing unit 1, then, on account of the detected configuration in the configuration memory 15, the loading of processing modes software can be blocked when such modes are outside the called-for hearing-aid hardware configuration. If, as shown schematically in FIG. 1, a transceiver 30 is used, by means of which the signal processing unit 1 is loaded in wireless manner with the desired processing program, then, as diagrammatically shown at the switch 17a, implementation using the transceiver 30 shall be precluded if the implementation is tried for a processing mode other than for the X, M, N configuration.

The output of the configuration memory 15 preferably is connected to an output HG_{A} of the hearing aid. When fitting the hearing aid to the patient, said output is fed to the PC supported fitting unit 19 whereby the hearing aid is identified by its individual configuration at the fitting unit 19. As shown in dashed lines, and in a preferred embodiment, the said output HG_{A} can be implemented by the transceiver (HG′_{A}). Basically a transceiver 30 is needed and most advantageous, even mandatory for binaural signal processing. In such a design the two signal processing units 1 are able to communicate with each other, or, in preferred manner, binaural signal processing may be carried out in a common unit 1.

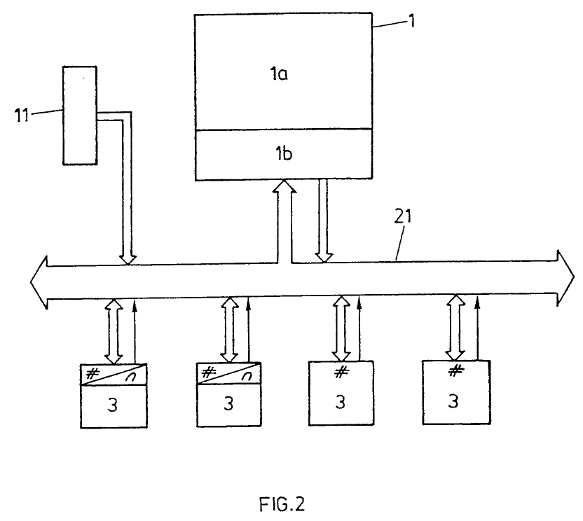

In a further preferred embodiment shown in FIG. 2, the communication between a central processing unit 1 and peripherals 3, further with the read-only memory 11, for instance an EEPROM, and, as regards hearing-aid fitting, with an external fitting apparatus, can be basically implemented using a bus 21 and interfaces of the cited units. Preferably standard interfaces shall be used (omitted)in particular simple ones, and especially having only two- or three-signal lines such as and preferably I²C and I²S interfaces such as are presently marketed by Philips, or AES-3 interfaces (Audio-Engineering Society) or SPI interfaces (Motorola).

As further shown in FIG. 2, a two-way communications link is in place at least partly and by means of a bus 21 between the peripherals 3 and the central signal processing unit 1, whereby further specific values such as further configuration parameters, optional and/or revised data can be transmitted jointly with the component identification shown in FIG. 1 from the peripherals to the central processing unit, and from the central signal processing unit 1, data can be sent back to the peripherals. Preferably and as shown in FIG. 2, the central signal processing unit 1 includes a signal processing component la as well as controller component lb which through the bus 21 controls and monitors the identification of configuration.

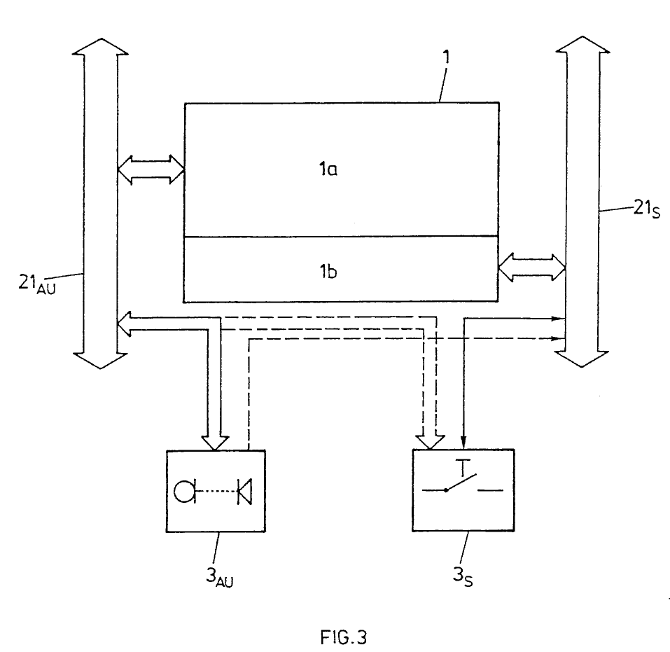

FIG. 3 shows a preferred embodiment of the principle disclosed in FIG. 2. The peripherals basically are divided into audio-signal units or components 3_{AU} and control units or components 3_{S} and, depending on type, are treated as audio-signal components or pure control components or, in this respect, in a hybrid constellation. The audio components 3_{AU} are connected through a first bus 21_{AU} and (omitted) corresponding interfaces to the signal processing component 1a of the signal processing unit 1, whereas the control components 3_{S} are connected through a second bus 21_{S} to the control component 1b of the signal processing unit 1, again by means of corresponding interfaces. Preferably interfaces of different specifications are used for the connection between the audio components 3_{AU}, the bus 21_{AU} and the signal processing component 1a than for the connection between the control components 3_{S}, the bus 21_{S} are and for the controller component 1b.

Preferably three-wire interfaces preferably based on the I²S interfaces cited above are used for the former connection.

As regards the latter connection, namely the real control connection, preferably two-wire interfaces are used, in particularly preferably based on the above cited kind of I²C interfaces.

As shown in dashed lines, hybrid peripherals participating in the audio signal processing and being controlled and vice-versa, are each connected to the correspondingly preferred audio signal interfaces or control interfaces, additionally also to the second of the buses provided.

The module of the invention offers a real “plug and play” modular system for hearing aids allowing sharply lowering manufacturing costs, minimizing the connection configuration at the central signal processing unit and in particular substantially precluding erroneous packaging, erroneous configurations, mismatching etc. based on human inattentiveness.

What is claimed is:

1. A hearing device comprising:
a digital signal processing unit having inputs and outputs;
at least one self-contained hardware unit, peripheral with respect to said digital signal processing unit and operationally connected to said inputs of said digital signal processing unit;
an identification means in said peripheral self-contained hardware units, the identification means having an output and containing identification information identifying said hardware unit;
a storage unit remote from said hardware unit containing identification information identifying more than one hardware peripheral unit and having an output;
a comparing unit remote from said hardware unit and having a first input, a second input, and an output, said output of said identification unit being operationally connected to the first inputs and said output of said storage unit being operationally connected to the second input and
a memory unit being operationally connected to the output of said comparing unit for storing the current configuration of said hearing device with respect to said peripheral self-contained hardware unit.

2. The device of claim 1, wherein the output of said comparing unit is operationally connected to a control input for the operation of said digital signal processing unit.

3. The device of claim 1, wherein said at least one of said self-contained peripheral hardware units and said digital signal processing unit is operationally connected via at least one data bus and interface unit.

4. The device of claim 1, further comprising an output of said device which is operationally connected to an output of said memory unit.

5. The device of claim 3, wherein said interface unit is one of a three-wire interface unit and a two-wire interface unit.

6. The device of claim 1, further comprising at least a second of said at least one self-contained hardware peripheral units, and wherein:
said one of said self-contained hardware peripheral units treating audio signal components of said device and being operationally connected to said digital processing unit via a first data bus with first interface units; and
said second of said self-contained hardware peripheral units treating control signals of said hearing device and being operationally connected with said digital signal processing unit via a second data bus and second interface units.

7. The device of claim 1, wherein said at least one peripheral self-contained hardware unit treats audio signal components of said hearing device and is operationally connected to said digital signal processing unit via a data bus with at least three-wire interface units.

8. The device of claim 1, wherein said at least one hardware peripheral self-contained hardware unit treats control signals of said hearing device and is operationally connected to said digital signal processing unit via a data bus with two-wire interface units.

9. The device of claim 7, wherein said three-wire interface units are I²S units.

10. The device of claim 8, wherein said second interface units are I²C units.

11. The device of claim 1, wherein said one self-contained hardware peripheral unit comprises one of a sensor, an actuator, a transceiver, a manually operable selection switch unit, and a potentiometer.

12. The device of claim 4, wherein said output of said device is an output of a transceiver.

13. The device of one of the claims 1 to 12, wherein said peripheral self-contained hardware unit comprises a microphone.

14. The device of claim 13, wherein said unit is a microphone.

15. The device of one of the claims 1 to 14, wherein said self-contained hardware unit having said identification means is an analogue unit.

16. A method for manufacturing a hearing device, comprising the steps of:
providing a signal processing unit;
providing at least one self-contained peripheral hardware unit;
operationally connecting said peripheral self-contained hardware unit to said signal processing unit; and
automatically identifying said peripheral self-contained hardware unit; and
storing the current hardware configuration of the hearing device with respect to said peripheral units.

17. The method of claim 16, further comprising a step of selecting an operational mode of said signal processing unit as a function of said current hardware configuration.

18. The method of claim 16, further comprising a step of barring an operation of said digital signal processing unit which does not conform with said current hardware configuration.

19. The method of claim 16, further comprising a step of providing treating of signals towards and/or from said digital signal processing unit as a function of said current hardware configuration.
